(19) United States
(12) Patent Application Publication
(10) Pub. No.: US 2003/0183018 A1
(43) Pub. Date: Oct. 2, 2003

(54) Flow meter as an irrigation management tool

(76) Inventors: John W. Addink, Riverside, CA (US); Sylvan Addink, Riverside, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/357,861

(22) Filed: Feb. 3, 2003

Related U.S. Application Data
(63) Continuation-in-part of application No. 09/852,230, filed on May 8, 2001.
(60) Provisional application No. 60/209,709, filed on Jun. 5, 2000.

(51) Int. Cl. G01F 1/34

(52) U.S. Cl. 73/861.69

(57) ABSTRACT

The present invention provides a flow meter comprising a microprocessor that calculates an applied irrigation amount for a time period for an area of an irrigated site. Additionally, the microprocessor determines a calculated watering requirement and a mathematical relationship between the calculated watering requirement and the applied irrigation amount. The flow meter further comprises an output device that provides information on the applied irrigation amount and the result of the mathematical relationship to at least one of an irrigation user and a third party. Preferably the calculated watering requirement is at least partly derived from ETo data. It is further contemplated that the microprocessor, disposed in the flow meter, will also detect, record and display flow anomalies. The flow anomalies may be due to power outages, flow meter malfunctions, and so forth.

This application is a Continuation-In-Part of U.S. patent application Ser. No. 09/852230 filed on May 08, 2001, which claims priority to U.S. provisional application number 60/209709 filed Jun. 05, 2000, both incorporated herein by reference in their entirety.

### FIELD OF THE INVENTION

The field of the invention is irrigation systems.

### BACKGROUND OF THE INVENTION

In arid areas of the world water is becoming one of the most precious natural resources. Meeting future water needs in these arid areas may require aggressive conservation measures, including efficient irrigation management systems. Efficient irrigation management systems involve the irrigation of a plant based on the plant's actual water requirements. A method for determining a plant's water requirements is to determine the quantity of water that is removed from the soil by evapotranspiration. Evapotranspiration is the process by which water is removed from the soil by direct evaporation from the soil and plant and by transpiration from the plant surface. If the amount of water that is removed by evapotranspiration (ETo) is replaced, this generally meets the water requirements of the plants. Irrigation controllers that derive all or part of an irrigation schedule from ETo data (ET irrigation controllers) are discussed in U.S. Pat. No. 5,479,339issued December 1995, to Miller, U.S. Pat. No. 5,097,861 issued March 1992 to Hopkins, et al., U.S. Pat. No. 5,023,787 issued June 1991and U.S. Pat. No. 5,229,937 issued July 1993 both to Evelyn-Veere, U.S. Pat. No. 5,208,855, issued May 1993, to Marian, U.S. Pat. No. 5,696,671, issued December 1997, and U.S. Pat. No. 5,870,302, issued February 1999, both to Oliver, U.S. Pat. No. 6,102,061, issued August 2000, and U.S. Pat. No. 6,298,285 both to Addink and U.S. Pat. No. 6,453,216, issued September 2002 to McCabe, et al.

Irrigation that is based on evapotranspiration generally involves the irrigation user accessing some source from which to obtain daily or weekly ETo data. Sources of ETo data can include CIMIS (California Irrigation Management Information System, maintained by the California Department of Water Resources), CoAgMet maintained by Colorado State University-Atmospheric Sciences, AZMET maintained by University of Arizona-Soils, Water and Environmental Science Department, New Mexico State University-Agronomy and Horticulture, and Texas A&M University-Agricultural Engineering Department and many other governmental and non-governmental sources. The irrigation user then develops an irrigation schedule based on the ETo data received. The problem is that the irrigation user generally does not have a reasonable and effective method to determine whether or not he/she actually applied the right amount of water to replace the water removed from the soil by evapotranspiration. Some use the manufacturers'specification for their irrigation system but this can vary substantially due to variation in water pressure and other inherent variability in irrigation systems that will affect the irrigation application rate. In crop production, some irrigation users use personal computers in their offices or other computing devices to which information on irrigation water usage is transmitted, but this generally involves substantial expense and therefore few producers invest in this technology.

Flow meters are used with some irrigation systems and are discussed in U.S. Pat. No. 4,209,131issued June 1980, to Barash, U.S. Pat. No. 5,176,163issued January 1993, to Al-Hamlan, U.S. Pat. No. 5,241,786issued September 1993, to Burns, et al., U.S. Pat. No. 5,971,011 issued October 1999, to Price, U.S. Pat. No. 6,343,255B1 issued January 2002, to Peek et. al. and patents 5,097,861, 5,229,937, 6,102,061, 6,398,385and 6,453,216mentioned above. Irrigation systems discussed in patents 4,209,131, 5,176,163, 5,229,937, 5,241,786and 6,102,061use the flow meter primarily to set limits to the quantity of water that will be applied by the irrigation system. In patents 5,097,861, 5,971,011and 6,398,385the flow meters are primarily used for leak detection. Water flow meters marketed today generally provide the flow rate and total flow, which is continuously accumulated. The flow data is obtained from the flow meter and then used by a separate device to calculate a quantity of water applied for a specific time period for a specific area of land. It is important to recognize that these calculations are done by microprocessors disposed in devices separate from the flow meter. Few irrigation users determine the actual water applied for a specific time period to a specific area of land due to the substantial expense involved in installing a system to obtain the flow data and then the additional expense and time required to perform the calculations to arrive at the actual water applied for a specific time period to a specific area of land.

The irrigation users will likely not change their irrigation practices until they are made aware of how inefficient their watering practices are. What is needed is reasonable and effective methods and devices that will accurately determine the amount of water applied for a specific time period to a specific area of land. Additionally, the methods and devices must provide the irrigation user with information on the amount of water that should have been applied to a specific area of land and the amount of water that actually was applied to the specific area of land.

### SUMMARY OF THE INVENTION

A flow meter having a microprocessor that calculates an applied irrigation amount for a time period for an area of an irrigated site. Additionally, a flow meter can be coupled to an output device that provides information on the applied irrigation amount to at least one of an irrigation user and a third party.

It is generally contemplated that the time period for determining the applied irrigation amount is at least 10 seconds.

The irrigated site may be an agricultural site, horticultural site or any other irrigated site.

The output device may be a display screen, printed material, an audible device, such as a telephone or any other type of output device that communicates applied irrigation information to the irrigation user and/or a third party.

Applied irrigation information preferably includes information concerning the amount of water that was applied to the irrigated area during an prior irrigation event, second to last irrigation event and so forth. Additionally, applied irrigation information may include an amount of water that was applied to the irrigated area during the last seven days, last thirty days or any other appropriate interval of time. In some embodiments, applied irrigation information may include information received from other sensors such as a water pressure sensor, a temperature sensor, a rainfall sensor, a wind sensor and so on.

In a preferred embodiment of the present invention a microprocessor, disposed in the flow meter, also determines a calculated watering requirement. Additionally, it is contemplated that the microprocessor will determine a mathematical relationship between the calculated watering requirement and the applied irrigation amount. The output device can provide the result of the mathematical relationship to at least one of an irrigation user and a third party.

In a preferred embodiment, the calculated watering requirement is at least partly derived from ETo data. The ETo data may be potential ETo data, estimated ETo data or historical ETo data. Furthermore, the ETo data may be received from a device local to the irrigation site or distal to the irrigation site. In other aspects, the calculated watering requirement may be at least partly derived from a crop coefficient value and an irrigation efficiency value. A ratio of the watering requirement to the applied irrigation amount may be calculated. Alternatively or additionally, a difference between the calculated watering requirement and the applied irrigation amount may be calculated. Other suitable mathematical calculations may also be made using the calculated watering requirement and the applied irrigation amount.

An additional application of the present invention, beside the determination of the applied and calculated watering amounts, is the detection, recording and displaying of flow anomalies to irrigation users and/or third parties. Preferably, the microprocessor, disposed in the flow meter, determines if a flow anomaly occurred, records when the flow anomaly occurred and displays information on the flow anomaly to at least one of an irrigation user and a third party. A flow anomaly may be due to a power outage, a flow meter malfunction, human intervention, a broken water line, a leaky seal, and other factors that may cause a faulty calculation of applied irrigation amount.

It is further contemplated that the microprocessor, disposed in the flow meter, will determine, record and display data anomalies from other devices, including pressure sensors, temperature sensors and any other sensor or device that is connected to the flow meter.

Various objects, features, aspects, and advantages of the present invention will become more apparent from the following detailed description that describes a preferred embodiment of the invention, along with the accompanying drawings in which like numerals represent like components.

### BRIEF DESCRIPTION OF THE DRAWINGS

FIG. 1 is a block diagram of an irrigation system according to the present invention.

FIG. 2 is a schematic of a flow meter as part of an irrigation system.

FIG. 3 is a flow chart of steps involved in determining an applied irrigation amount.

FIG. 4 is a flow chart of steps involved in a preferred embodiment of the present invention.

FIG. 5 is a flow chart of steps involved in an embodiment of the present invention.

### DETAILED DESCRIPTION

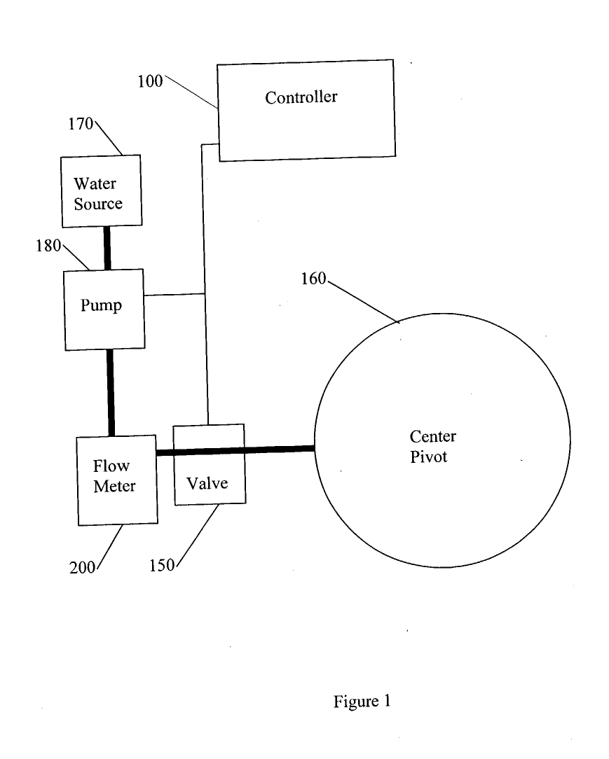

FIG. 1 is an example of an irrigation system according to the present invention. Controller 100 may be an automatic irrigation controller, a manual input controller, a personal computer or any other device that is appropriate for controlling an irrigation system. The controller 100 operates one center pivot irrigation unit 160. An agricultural center pivot 160 is shown but it can be appreciated that the inventive concept could apply to linear moving lines, wheel lines, underground sprinklers, and any other irrigation system. Further, it will be understood that only one center pivot 160 is shown but this is not to be interpreted as limiting the number or configuration of center pivots or other irrigation units. Among other things, the controller 100 starts a pump 180 (not used with every irrigation system) and operates solenoids (not shown), which open valve 150 to allow irrigation water to flow from a water source 170 to be applied through the center pivot 160. A flow meter is generally positioned between a pump (a water source , if no pump is present) and a valve. However, it is contemplated that a flow meter may be positioned after a valve but before the sprinklers in certain situations.

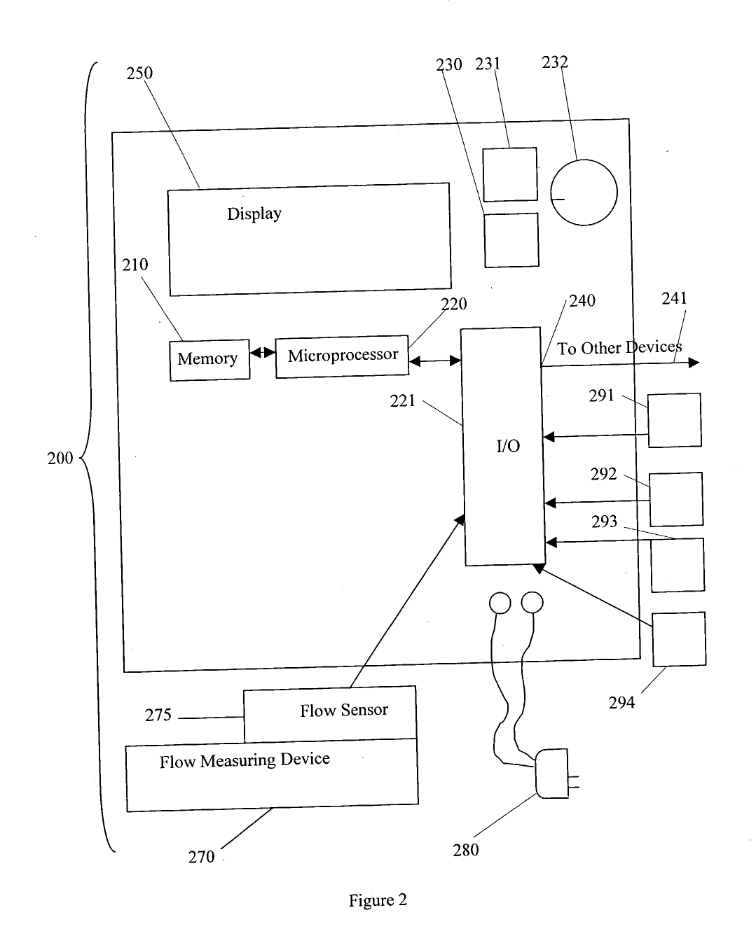

FIG. 2 is a schematic of a water flow meter 200 according to an aspect of the present invention that includes a microprocessor 220, an on-board memory 210, some manual input devices 230 through 232 (buttons and/or knobs), an input/output (I/O) circuitry 221 connected in a conventional manner, a display screen 250, a communications port 240, a serial, parallel or other communications connection 241 coupling the flow meter to other devices, such as personal computers, telephone lines, radio transmitters, etc., a water flow measurement device 270, a flow sensor 275, a power supply 280, a rain detection device 291, a wind sensor 292, a water pressure sensor 293 and a temperature sensor 294. Each of these components by itself is well known in the electronic industry, with the exception of the programming of the microprocessor in accordance with the functionality set forth herein. There are hundreds of suitable chips that can be used for this purpose. At present, experimental versions have been made using a generic Intel 80C54chip, and it is contemplated that such a chip would be satisfactory for production models.

In a preferred embodiment of the present invention a water flow meter has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to a rain detection device 291, a wind sensor 292, water pressure sensor 293, and a temperature sensor 294.

A power supply 280 can be electricity, battery or any other suitable power supply.

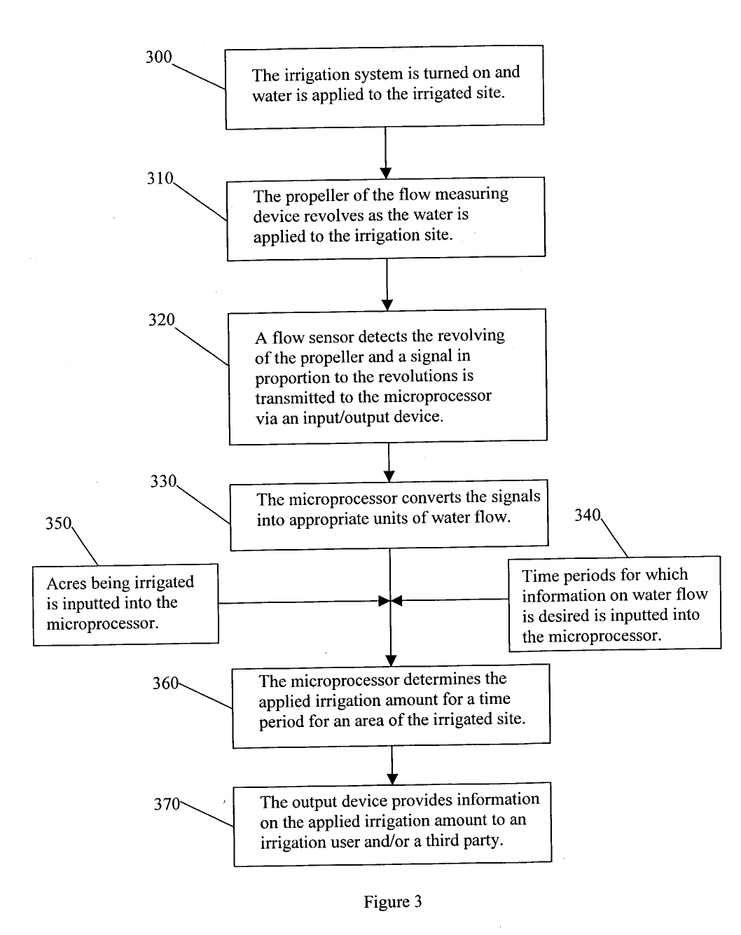

In FIG. 3, the first step in the determination of the applied irrigation amount for a time period for an area of an irrigated site is turning the irrigation system on and applying water to the irrigated site 300. The flow measuring device is activated by the flow of water through the pipe, which in the example in step 410 involves the revolving of a propeller due to the flow of water past the propeller blades. Although, a preferred flow measuring device is one that comprises a propeller flow meter, it can be appreciated that a flow measuring device could comprise an ultra sonic flow meter, an impeller type flow meter, or other suitable flow measuring device. In step 310 a flow sensor detects the revolving of the propeller and a signal, in proportion to the revolutions sensed, is transmitted to the microprocessor via an input/output device (See FIG. 2, 221).

In step 330, the microprocessor converts the signals into appropriate units of water flow. The units of water flow may be gallons per minute, acre inches, acre feet or any other suitable water flow measurement unit. The microprocessor then determines the applied irrigation amount for a time period for an area of the irrigated site 360. The time period(s), for which information on water flow is desired, may be inputted into the microprocessor at the factory, by the irrigation user or at any other suitable time by any appropriate means 340. The time periods generally relate to a prior irrigation event and may include the last irrigation event, the second to last irrigation event, up to the nth to last irrigation event. Alternatively or additionally the time periods may include the water applied during the last seven days, the last thirty days or any other interval of time. An area of the irrigated site is defined by the acres inputted in the microprocessor 350.

As mentioned above, the microprocessor determines the applied irrigation amount for a time period for an area of the irrigated site 360. Following is an example of a preferred calculation that would be conducted in the microprocessor in the determination of the applied irrigation amount for a time period for an area of an irrigated site. Assume that one of the desired time periods that was inputted into the microprocessor was the last irrigation event. Further, assume that the last irrigation event started at 05:33 am on Sep. 3, 2002, ended at 05:33 pm on Sep. 5, 2002and a flow measurement of 92.8 acre inches of water was determined to have flowed through the flow meter during this interval of time. The flow meter would date and time stamp when the last irrigation event started and when it ended and the quantity of water that was applied during this time period. If the acres inputted in the microprocessor was 130 acres (This is frequently the number of acres irrigated by a center pivot) then the microprocessor would automatically determine that 0.71inches of water was applied to the 130 acres during the 60 hour period (92.8 acre inches divided by 130 acres). If no more water is applied on Sep. 5, 2002, the 0.71 inches would be the total applied irrigation amount for the three day period from Sep. 3 to Sep. 5, 2002.

The output device provides information on the applied irrigation amount to an irrigation user and/or third party 370. Additionally, the output device may provide information obtained from other devices or sensors, such as, a rain detection device (See FIG. 2, 291), a wind sensor 292, a water pressure sensor 293 and a temperature sensor 294 or any other devices connected to the flow meter. The output device may comprise visual or audible devices such as a display screen, printed material, an e-mail message, a telephone, a pager, or any other type of output device that effectively communicates the information to the irrigation user and/or a third party. It is further contemplated that the information maybe transmitted to either a handheld computer (Personal Digital Assistant) or other computer device that can be used to display the information directly to the irrigation user and/or third party in the field. Additionally, the personal digital assistant maybe used to transfer the data from the flow meter to a personal computer. At the personal computer the downloaded information can be graphed and/or displayed in other appropriate format to the irrigation user and/or third party. The personal computer can also be used for the storing of a large quantity of flow data that could not be done by the flow meter or the personal digital assistant.

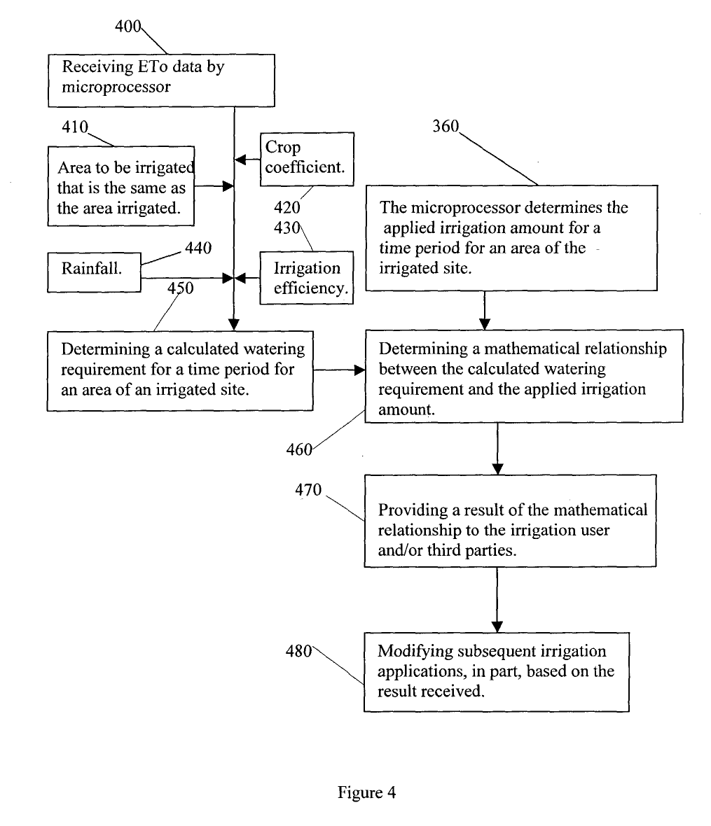

In a preferred embodiment of the present invention a microprocessor would also determine a calculated watering requirement. The microprocessor, in the determination of the calculated watering requirement, may receive ETo data from a distal source, such as from a weather station, radio station or some other distal source via a telephone line, radio, pager, two-way pager, internet, cable, or any other suitable communication mechanism (FIG. 4, step 400). It is also contemplated that the microprocessor may receive the ETo data or weather data from which the ETo data is determined from a local source such as, sensors at the irrigation site or other local sources. The ETo data, from which the calculated watering requirement is derived, may advantageously comprise current ETo data (i.e., within the last week, three days, or most preferably within the last 24 hours). The current ETo data may be potential ETo data that is calculated based on the following four weather factors; solar radiation, temperature, wind, and relative humidity. Alternatively, the current ETo data may be estimated ETo data (as for example that described in pending U.S. patent application Ser. No. PCT/US00/18705) that is based upon a regression model using one or more of the weather factors used in calculating the potential ETo. The ETo data used in determining the calculated watering requirement may also be historical ETo data.

In step 450 the microprocessor determines the calculated watering requirement for a time period for an area to be irrigated 410. The area 410 corresponds to the area to which the irrigation was applied (FIG. 3, Step 350). The area irrigated or to be irrigated is preferably stored in the memory but may be inputted into the microprocessor at any time prior to the determination of the applied irrigation amount and/or the calculated watering requirement.

It is contemplated that, in addition to ETo data 400 and an area to be irrigated 410, the calculated watering requirement determination 450 may be based on other information stored in the memory and or received by the microprocessor that would help in the determination of the best estimate of the water requirements for the plants grown at the irrigated site. Other information may include such factors as, a crop coefficient value 420, an irrigation efficiency value 430, rainfall data 440 and other meteorological, geographical, soil, etc. information.

Preferably, the time period that the calculated watering requirement is determined for is one day. Most ETo data that is provided by government agencies, weather stations, and so forth is based on one day periods of time. However, it may be a time period other than one day. It is additionally contemplated that the calculated watering requirement may be a plurality of periods of time, for example, daily periods may be accumulated to arrive at a calculated watering requirement for a seven day period, a thirty day period and so forth.

In step 460, a mathematical relationship is determined between the calculated watering requirement 450 and the applied irrigation amount 360. The mathematical relationship may be a ratio of the calculated watering requirement to the applied irrigation amount, the difference between the calculated watering requirement and the applied irrigation amount or any other suitable mathematical relationship between the calculated watering requirement and the applied irrigation amount.

The following calculations are based on the above information on the last irrigation event that was started at 05:33 am on Sep. 3, 2002and ended at 05:33 pm on Sep. 5, 2002. Assume that the calculated water requirement for Sep. 2, 3 and 4, 2002 was 0.19, 0.21 and 0.17 inches, respectively. Preferably water is applied the following day to replace the water that was removed by evapotranspiration the previous day. The total calculated water requirement for the three days would be 0.57 inches. It was determined above that the applied irrigation amount for the three days was 0.71 inches or there was an excess of 0.14 inches (0.71 inches-0.57 inches) of water applied to the 130 acres during the three day period. Based on the above information, the irrigation user would know that he or she had over applied water to the irrigated site and could make appropriate adjustments to future irrigation applications.

In a preferred embodiment of the present invention the results from the determination of the mathematical relationship between the calculated watering requirement and the applied irrigation amount are provided to the irrigation user and/or third parties 470. The results may be provided as a ratio, a difference, a graph, actual values of the calculated watering requirement and the applied irrigation amount, or any other suitable form that aids the irrigation user and/or third party in the efficient management of the irrigation system.

The output device may display the results to the irrigation user and/or third parties. Displays can be any reasonable size, shape, composition, and so forth. Display 210 in FIG. 2 is a few inches on a side, and is an LED or liquid crystal type display. Other displays may be located away from the flow meter such as in a personal computer. It is also contemplated that the results may be communicated to the irrigation user and/or third parties through means other than liquid crystal type displays, such as through printed material, audible messages, such as via a telephone system or any other suitable means that would communicate the results to irrigation users and/or third parties.

It is contemplated that the irrigation user is a human being that uses the irrigation system locally, or is responsible for local monitoring or controlling of the irrigation system at the property. For a residential property, the irrigation user is usually the homeowner or a renter. In a commercial or agricultural setting, the irrigation user is usually an employee of the property owner, manager, leaser, or renter. Formal title of irrigation users is not important, as the irrigation user at a commercial property may be referred to as an engineer, building supervisor, etc.

Third party is a legal person other than the irrigation user that has an interest in the irrigating done by the irrigation user. A third party need not be a physical person, and may well be a water district or other government agency, or an individual or company involved in the care or management of the property, but not locally situated at the property.

Preferably, the irrigation user will use the results to modify subsequent irrigation schedules with the expectation of improving the efficiency of the irrigation system 480. For example, if the calculated watering requirement is more than the applied irrigation amount, subsequent irrigation times may be reduced, which will in turn reduce the potential waste of water. If dry spots occur with a reduction in the irrigation amount, but the applied irrigation amount still exceeds the calculated watering requirement, the irrigation system should be checked for distribution uniformity problems, since some irrigated areas may be receiving excessive amounts of water while other areas are turning brown, due to lack of water.

Using the relationship of a calculated watering requirement to an applied irrigation amount may also be a tool that water districts could use during a time when there is a water shortage to motivate irrigation users to practice efficient irrigating of their landscapes based on ETo data.

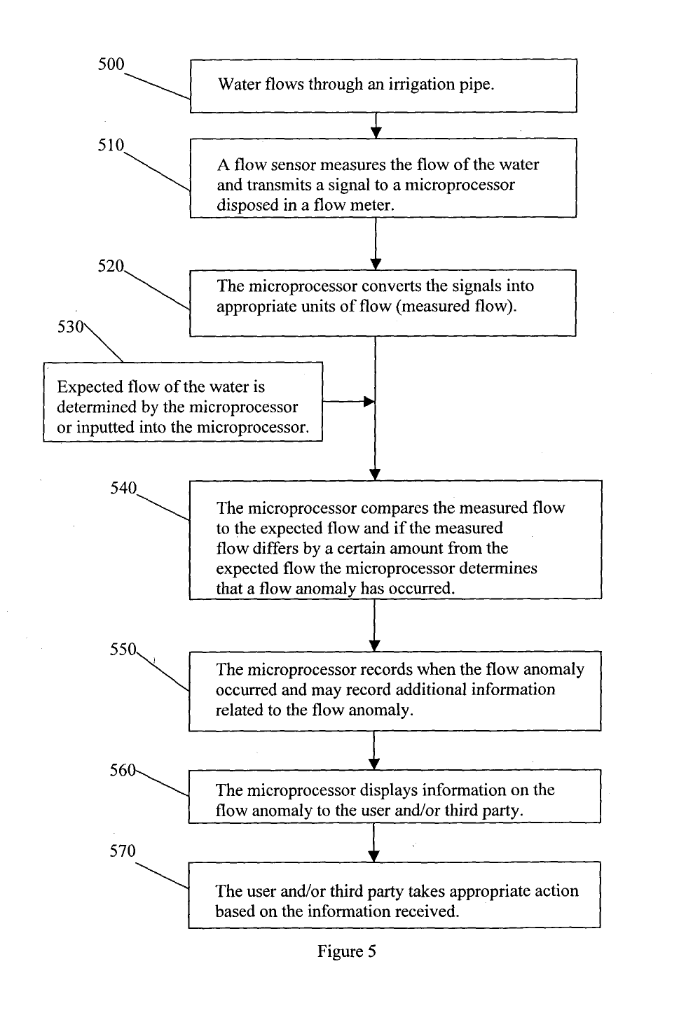

FIG. 5 is a flow chart of an additional application of the present invention. This additional application involves the detection, recording and displaying of flow anomalies to irrigation users and/or third parties. It is contemplated that the microprocessor, disposed in the flow meter, will determine if a flow anomaly occurred, record when the flow anomaly occurred, and display information on the flow anomaly to at least one of an irrigation user and a third party.

In step 500, water flows through an irrigation pipe. In step 510, a flow sensor detects the flow of the water and transmits a signal to the microprocessor, disposed in the flow meter. The signal should be proportional to the flow of the substance but due to flow meter malfunctions or for other reasons the signal may not always be proportional to the flow.

In FIG. 5, step 520, the microprocessor converts the signals to appropriate units of flow rate, including gallons per minute, cubic feet per second, and so forth or to appropriate units of total flow, including gallons, acre feet and so forth. The signals that are converted to appropriate units of flow rate and total flow are hereinafter, termed measured flow rate or measured total flow, respectively.

In a preferred embodiment of the present invention, the microprocessor, disposed in the flow meter, is programmed to automatically determine an expected flow of a substance 530. This can be an expected flow rate and/or an expected total flow of the water during a specific period of time. For example, assume the average flow rate for an irrigation system is 600 gallons per minute. The microprocessor is programmed to learn that 600 gallons per minute is the average flow rate and the microprocessor will use this average flow rate as the expected flow rate. The microprocessor may be programmed to learn the flow rate and or total flow by making hourly checks of the flow rate and/or total flow. Alternatively, the learning may occur over a period of a day, a week or any other appropriate length of time. Additionally, the microprocessor may be programmed to learn the expected flow rate or expected total flow by taking three successive samples of the flow rate or total flow and then taking an average of the three samples. Alternatively, the microprocessor may be programmed to learn the expected flow rate or total flows by sampling less than or more than three successive times or intervals of time, respectively.

It is further contemplated that instead of the microprocessor being programmed to automatically determine the expected flow rate and/or total flow, the expected flow, either flow rate or total flow, will be inputted (e.g. manually)into the microprocessor by the user at the site, at the factory, or by any other appropriate means 530.

In FIG. 5, step 540 the microprocessor compares the measured flow rate or measured total flow to the expected flow rate or expected total flow, respectively. If the measured flow rate or measured total flow differ by a certain percentage from the expected flow rate or expected total flow, respectively, then the microprocessor may determine that a flow anomaly has occurred. The term ‘flow anomaly’ as used herein, refers to a measured flow rate or measured total flow that varies from the expected flow rate or expected total flow by a predetermined percentage. The predetermined percentage can vary based on the irrigation site, acceptable flow error and other factors. The predetermined percentage can be inputted into the microprocessor by the user at the site, at the factory, or by any other entity and by any. appropriate means. It can be appreciated that the difference between the measured flow and the expected flow may be something other than a percentage, such as, a numeric value or any other appropriate means used to define a difference between the measured flow and the expected flow, but such difference may be converted into a percentage for comparison purposes.

There are several factors that may cause a flow anomaly. A flow anomaly may be due to the fact that no flow was detected because there was a power outage and therefore no power was provided to the flow meter to allow it to measure the flow. It may be due to an error in the measurement of the flow rate because of excessive flow meter wear due to the age of the flow meter. Additionally, a foreign object in the flow stream may prevent the flow from being measured correctly. For example, with a water propeller flow meter, if some foreign debris would catch on the propeller this may prevent the propeller from turning in proportion to the flow of the water through the pipe and an inaccurate meter reading would be obtained. In addition to the flow meter malfunctions listed above, there are many other flow meter malfunctions that could cause a flow anomaly to occur. Furthermore, pipe leakage, and other liquid transfer system problems could cause flow anomalies.

It is further contemplated that there could be factors, other than flow meter malfunctions or water transfer system problems that could cause flow anomalies to occur. These could include human interventions. Humans may effect the flow rate or total flow of a substance by their actions,. For example, assume that the flow rate that would allow for the most uniform distribution of the water to an irrigated site is 600 gallons per minute. If an excessive number of sprinklers were turned on, a flow rate of greater than 600 gallons would likely occur and the irrigation uniformity could be negatively effected. Although, only one example of human intervention causing a flow anomaly is listed above, it can be appreciated that there are many other instances where the actions of humans may cause differences to occur between the measured flow rate or measured total flow and the expected flow rate or expected total flow, respectively.

In a preferred embodiment of the present invention the microprocessor would record and save information on the flow anomaly FIG. 5, 550 in non-volatile memory (see FIG. 1, 210). The flow meter may have a real time clock disposed in it and whenever the microprocessor determines that a flow anomaly occurred, it may date and time stamp the flow anomaly beginning and ending times. For example, when an irrigation flow meter has a power outage, it is contemplated that the microprocessor would have date and time stamped every day prior to the power outage and therefore would not have date and time stamped the days when the power outage occurred. As soon as power is restored to the flow meter the microprocessor will again date and time stamp each day. This data can be kept in non-volatile memory. The power outage period is generally calculated as the time period during which the power was out as indicated by the date and time stamps. Additionally, it is contemplated that the microprocessor will have kept daily records of the irrigation water usage prior to the power outage as indicated earlier (FIG. 3). The information on the flow anomaly and information related to the flow anomaly, such as, the daily records on irrigation water usage, may be kept in non-volatile memory for preferred periods of one month and even more preferred periods of one year or longer.

In a preferred embodiment of the present invention, information on the flow anomaly may be displayed to the user and/or third party 560. With the power outage example above, the information would include the date of the day before the power outage occurred, the date when the power outage ended and information on the daily irrigation water usage prior to the time of the power outage. If the water district had allocated to the irrigation user a specific amount of water that could be used during the year for irrigation, the water district can now use the recorded information to estimate how much water was used during the period when the power outage occurred and add that to the total flow data that was actually measured. It is contemplated that the inventive concepts described above could be used with any commodity including water, electricity or gas.

As flow meters age, they may no longer accurately measure the flow of a substance due to excessive wear. Additionally, as mentioned earlier, flow meters may be effected by foreign materials. The foreign material may impede the operation of the flow meter and cause a lower than actual flow rate to be detected by the flow sensor. There is a problem is determining when a flow meter is no longer accurately measuring the flow of a substance. The invention described herein will aid in determining when a flow meter may be malfunctioning and not providing an accurate measurement of the actual flow of the substance. If the flow rate or total flow is fairly constant during any period of a day, week or other time period, the microprocessor, disposed in the flow meter, can learn the constant flow rate or total flow and use these values as the expected flow rate or expected total flow. These values can be compared to future measured flow rates or measured total flows (FIG. 5, 530 and 540). If the difference exceeds a certain percent, the microprocessor may determine that a flow anomaly occurred and will record (e.g. by date and time stamp), when the flow anomaly occurred as well as additional information related to the flow anomaly 550. Information on the flow anomaly will advantageously be displayed to the user and/or third party 560. The user and/or third party can then check whether there is a problem with the flow meter and either repair the flow meter or replace it with a new flow meter that accurately measures the flow of the substance 570. If the flow data is used for billing purposes or for allocation purposes then, as mentioned above, with the power outage, the water district can use the date and time stamped information stored in the non-volatile memory to estimate the amount of commodity usage during the period when the flow meter was malfunctioning.

An example of human intervention could be as simple as that mentioned above where an employee turns on too many irrigation sprinklers resulting in non-uniform distribution of the water because of the high demand for water. The manager may input into the microprocessor, disposed in the flow meter, on a daily, weekly or some other appropriate time period the expected flow rate and/or expected total flow (FIG. 5, 530). If the measured flow rate or total flow varies by a given percent, from the inputted expected flow rate or total flow, respectively, then the microprocessor will determine that a flow anomaly occurred 540. Information on the flow anomaly, as well as information related to the flow anomaly, will be recorded and displayed to the manager 550-560. The manager can then take appropriate steps to make sure their employees do not turn on excessive numbers of sprinklers in the future 570.

It is anticipated that information related to the flow anomaly may include the quantity of water that was applied during the last irrigation, during the last seven day period or during any other appropriate period of time as well as any additional information that might help the manager to determine if an actual flow problem exists. If a flow problem does exist, the manager can correct the flow problem and/or prevent the flow problem from occurring in the future. As far as a flow anomaly, it is contemplated that the microprocessor will date and time stamp when the flow anomaly started, including what the flow rate was at that time. The microprocessor will then date and time stamp when the flow anomaly ended, including, again, the flow rate when the flow anomaly ended. As far as monitoring total flow for a day, a seven day period, and so forth, it is contemplated that the microprocessor will date and time stamp the accumulated total flow at the beginning of the period and the accumulated total flow at the end of the period. The microprocessor will then preferably subtract the beginning accumulated total flow from the ending accumulated total flow to arrive at the total flow for the specified period of time. The measured total flow can be compared to the expected total flow and, if different by a predetermined percentage, then a flow anomaly is determined to have occurred 540. Information on the flow anomaly, whether flow rate and/or total flow can be displayed to the manager through the output device 560. If there is a flow anomaly, information on the flow anomaly and information related to the flow anomaly can be specifically brought to the attention of the manager. It is contemplated that this may be accomplished by a flashing display, a warning or other means that would get the attention of the manager (user) and/or third party. The warning may be through any suitable means, including, for example, an audible alarm, an alarm mechanism, and other warning means.

Information on the flow anomaly may be displayed as a ratio, a difference, a graph, actual values of the measured flow and expected flow or any other suitable form that aids the user and/or third party toward taking appropriate action to correct the flow anomaly and/or prevent the flow anomaly from occurring in the future.

As mentioned above, it is contemplated that a flashing display, warning, or other means would be used to alert the user and/or third party when the microprocessor determines that a flow anomaly has occurred. Additionally, in a preferred embodiment of the present invention the microprocessor can be programmed to stop the flow of the substance through the flow meter, if the difference between the measured flow rate exceeded a set percentage. Preferably, this percentage would be greater than the predetermined percentage used by the microprocessor to determine when a flow anomaly occurred, although, it could be the same percentage value. A condition that may prompt stoppage of the flow is a break in the irrigation line. If a break occurs, the measured flow rate may be significantly higher than the expected flow rate.

In addition to the detection and recordation of flow anomalies, it is contemplated that the microprocessor, disposed in the flow meter, may also be used to detect, record and display other anomalies, such as pressure anomalies, temperature anomalies, and so forth. Pressure is an important factor in water flow and gas flow. With irrigation systems, if the pressure is low, the distribution of the water will be adversely effected. As with the flow of water, so also with the measurement of pressure there will be an expected pressure and a measured pressure and if they vary by a predetermined percent then the microprocessor may determine that a pressure anomaly occurred. The pressure anomaly will be recorded, by date and time stamping the pressure anomaly event, along with other information related to the pressure anomaly. This information can be displayed to the user and/or a third party through the output device. The user and/or third party can then take appropriate action based on the information they receive.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A flow meter comprising a microprocessor that calculates an applied irrigation amount for a time period for an area of an irrigated site.

2. The flow meter of claim 1 communicatively coupled to at least one of an irrigation user and a third party.

3. The flow meter of claim 2 further comprising an output device that provides information on the applied irrigation amount to the irrigation user and/or the third party.

4. The flow meter of claim 1, wherein the time period is at least 10 seconds.

5. The flow meter of claim 1, wherein the irrigated site is an agricultural site.

6. The flow meter of claim 1, wherein the irrigated site is a horticultural site.

7. The flow meter of claim 3, wherein the output device is a display screen.

8. The flow meter of claim 3, wherein the output device is printed material.

9. The flow meter of claim 1, wherein the calculation comprises an amount of water that was applied to the irrigated site during a prior irrigation event.

10. The flow meter of claim 1, wherein the calculation comprises an amount of water that was applied to the irrigated site during the previous seven days.

11. The flow meter of claim 1, wherein the microprocessor calculates a watering requirement for the irrigated site.

12. The flow meter of claim 11, wherein the watering requirement is at least partly derived from ETo data.

13. The flow meter of claim 11, wherein the watering requirement is at least partly derived from a crop coefficient value.

14. The flow meter of claim 11, wherein the watering requirement is at least partly derived from an irrigation efficiency value.

15. The flow meter of claim 11, wherein the microprocessor determines a mathematical relationship between the watering requirement and the applied irrigation amount.

16. The flow meter of claim 15 wherein an output device provides a result of the mathematical relationship to at least one of an irrigation user and a third party.

17. The flow meter of claim 16, wherein the result comprises a ratio of the calculated watering requirement to the applied irrigation amount.

18. The flow meter of claim 16, wherein the result comprises a difference between the calculated watering requirement and the applied irrigation amount.

19. The flow meter of claim 1, wherein the microprocessor uses water pressure data in the calculation.

20. The flow meter of claim 1 wherein the microprocessor detects, records and displays flow anomalies.

21. The flow meter of claim 20, wherein the flow anomaly is due to a power outage.

22. The flow meter of claim 20, wherein the flow anomaly is due to flow meter malfunctions.

23. The flow meter of claim 20, wherein the flow anomaly is due to human intervention.

24. A method of collecting irrigation information, comprising: providing a microprocessor, disposed in a flow meter; and the microprocessor calculating an applied irrigation amount for a time period for an irrigated site.

25. The method of claim 24, further comprising the microprocessor calculating a watering requirement for the time period for the irrigated site.

26. The method of claim 25, further comprising the microprocessor determining a mathematical relationship between the watering requirement and the applied irrigation amount.
